(19) United States
(12) Patent Application Publication
(10) Pub. No.: US 2015/0381786 A1
(43) Pub. Date: Dec. 31, 2015

(54) Hands-Free Device Accessory

(71) Applicant: Mirza N. Baig, Woodlands, TX (US)

(72) Inventor: Mirza N. Baig, Woodlands, TX (US)

(73) Assignee: ABCD TECHNOLOGY, Woodlands, TX (US)

(21) Appl. No.: 14/316,771

(22) Filed: Jun. 26, 2014

(51) Int. Cl. H04M 1/12

(52) U.S. Cl. CPC H04M 1/12

(57) ABSTRACT

A device accessory system includes a support structure adapted to operatively connect to a user; a holding assembly including a device holder adapted to hold a mobile communication device, wherein the mobile communication device is adapted to capture data; an extendable and collapsible flexible positioning system that is positionable at varying lengths and angles to adjust a distance or angle between the mobile communication device and the user, wherein the flexible positioning system includes a first end coupled to the support structure, and a second end coupled to the holding assembly, wherein the data is captured once the flexible positioning system is positioned at a fixed distance or angle relative to the user, and wherein the data is captured in a hands-free utilization by the user; and a lock assembly operatively connected to the flexible positioning system.

### BACKGROUND

1. Technical Field

The embodiments herein generally relate to an apparatus for positioning a data capturing device, and more particularly to a portable apparatus that allows users to capture their own data without having to hold a data capturing device in their hands.

2. Description of the Related Art

Often, particularly during travels, people have the need to capture their own data (e.g., photos, audio, or video) using a data capturing device such as a camera. Cameras and recorders are a common feature of mobile phones that are typically carried in person, during such travels. However, despite the easy availability of a camera, it is not easy for someone to take a picture that includes himself/herself. Typically, the person needs assistance from someone else to capture the picture, which would typically be a stranger, or a professional. Alternatively, the person can take the picture by holding the mobile phone at a distance, and pointing it to face him/her (i.e., “selfies”).

However, taking one's own picture by holding a device with one's hand is cumbersome, and does not lead to a good quality picture of oneself, as well as one's surroundings. Further it requires one's hand to be free, and does not allow photographs to be taken while moving or performing actions such as walking, running, surfing, auto racing, or cycling. Pictures taken by holding a device with one's hand capture mostly only a person's face (e.g., because of the short distance between the device and person holding it), and do not effectively capture one's surroundings. Moreover, the person may shake the device while taking the picture, which adversely affects picture quality. Also, the user's hand can be extended only up to a limited distance (e.g., length of the person's arm), and not further.

There are wearable cameras such as helmet cameras that enable a user to take ‘action shots’ while on the move, but they only take pictures in front of the user, and not of the user itself. On the other hand, handheld mobile devices such as smartphones need to be held at arm's length without allowing both arms to be free, and do not effectively capture one's surroundings. There are tripod stands that enable cameras to be placed on specific surfaces, however, a surface may not be readily available nearby to place the camera, particularly while the user is on the move or in/on non-stable terrain. Further, when the device is placed on an external surface or when it is held while taking an ‘action shot’ when the user is moving, there is a risk of it falling or getting damaged due to contact with water, ice, or hard ground, etc. Accordingly, there remains a need for an apparatus that allows users to capture their own data without having to hold a data capturing device in their hands, without restricting themselves to a particular location or proximity to a surface.

### SUMMARY

In view of foregoing, an embodiment herein provides a device accessory system comprising a support structure adapted to attach to a user; a holding assembly comprising a device holder adapted to secure a data capturing device, wherein the data capturing device is adapted to capture data; and an extendable and collapsible flexible positioning system that is positionable at varying lengths and angles to adjust a distance or angle between the data capturing device and the user, wherein the flexible positioning system comprises a first end coupled to the support structure; and a second end coupled to the holding assembly, wherein the data is captured once the flexible positioning system is positioned at a fixed distance or angle from the user, and wherein the user does not have to hold the data capturing device while the data is being captured.

Any of the holding assembly and the device holder may be waterproof. The data may comprise any of audio, video, image, and biometric data. The support structure may be adapted to fit around the user. The support structure may comprise a clip. The support structure may be detachable. The support structure may be adjustable. Any of the holding assembly, the device holder, and the data capturing device may be movable. The device accessory system may further comprise a lock assembly operatively connected to the flexible positioning system. The lock assembly may be positioned adjacent to the first end.

Another embodiment provides a device accessory system comprising a support structure adapted to operatively connect to a user; a holding assembly comprising a device holder adapted to hold a mobile communication device, wherein the mobile communication device is adapted to capture data; an extendable and collapsible flexible positioning system that is positionable at varying lengths and angles to adjust a distance or angle between the mobile communication device and the user, wherein the flexible positioning system comprises a first end coupled to the support structure, and a second end coupled to the holding assembly, wherein the data is captured once the flexible positioning system is positioned at a fixed distance or angle relative to the user, and wherein the data is captured in a hands-free utilization by the user; and a lock assembly operatively connected to the flexible positioning system.

Any of the holding assembly and the device holder may be waterproof. The data may comprise any of audio, video, image, and biometric data. The lock assembly may be positioned adjacent to the first end. The lock assembly may comprise a turner, a locking plug, and a locking groove. The support structure may be adapted to fit around the user. The support structure may comprise a clip. The support structure may be detachable. The support structure may be adjustable. Any of the holding assembly, the device holder, and the mobile communication device may be movable.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates a top view of a hands-free device accessory which is adapted to fit the body of a user according to an embodiment herein;

FIG. 1B illustrates a top view of a hands-free device accessory which is adapted to fit the body of a user according to another embodiment herein;

FIG. 2 illustrates a front view of the hands-free device accessory that includes a support structure, which is adapted to fit the torso of a user, and a flexible positioning system in a partially extended state according to an embodiment herein;

FIG. 3 illustrates a front view of the hands-free device accessory that includes a support structure, which is adapted to fit the torso of a user, and a flexible positioning system in a fully extended state according to an embodiment herein;

FIG. 4 illustrates a side view of the hands-free device accessory that includes a support structure, which is adapted to fit the torso of a user, and a flexible positioning system in a fully extended state according to an embodiment herein;

FIG. 5 is an example of a data capturing device used in accordance with the embodiments herein; and

FIG. 6 is a flow diagram illustrating a method that allows a user to capture his/her own data using a hands-free device accessory according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

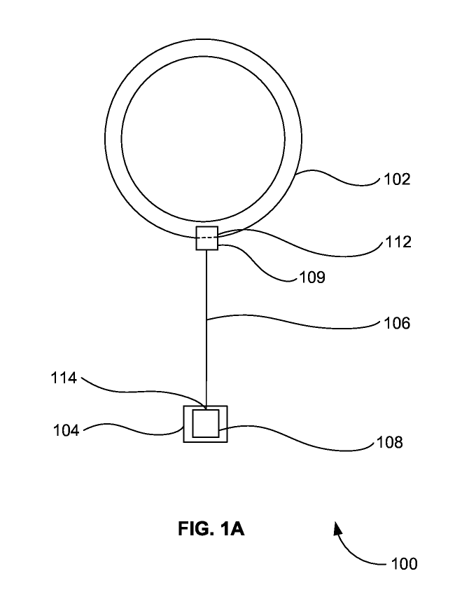

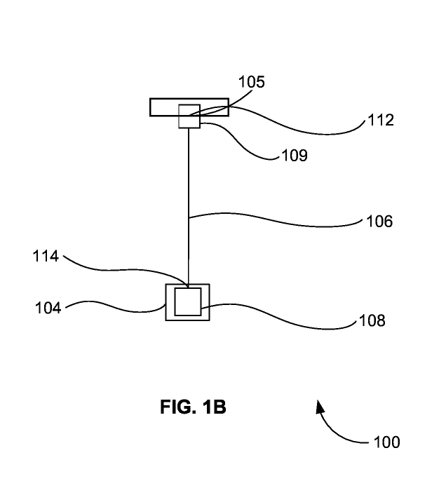

As mentioned, there remains a need for an apparatus that allows users to capture their own data without having to hold a data capturing device in their hands, and without restricting themselves to a particular location or proximity to a surface. The embodiments herein achieve this by providing a hands-free device accessory that includes an assembly for accommodating the data capturing device. The hand-free device accessory further includes a support structure that is adapted to fit the body of the user. When using the hands-free device accessory, a user does not have to hold a data capturing device on his/her hand when a data associated with the user is being captured. Referring now to the drawings, and more particularly to FIGS. 1A through 6, where similar reference characters denote corresponding features consistently throughout the figures, there are shown preferred embodiments.

FIG. 1A illustrates a top view of a hands-free device accessory 100 which is adapted to fit the body of a user according to an embodiment herein. The hands-free device accessory 100 includes a support structure 102, a holding assembly 104, and a flexible positioning system 106. The support structure 102 is adapted to fit the body of a user. In one embodiment, the support structure 102 is adapted to fit the waist of the user. The support structure 102 may be made of an elastic material containing a stiffening mechanism that is expandable to fit the body of the user. Alternatively, the support structure 102 may comprise a series of hinged components or a telescoping mechanism or is otherwise collapsible to provide the extendible/retractable functionality. The support structure 102 may also be adapted to fit other body portions (e.g., torso, hand, shoulder, and/or neck) of the user. In one embodiment, the support structure 102 may be a waist band with a Velcro® connection belt for fastening the support structure 102 to the body of the user. In one embodiment, the support structure 102 may be configured as a clip 105 (as shown in FIG. 1B) to fasten the end of the support structure 102 to the body of a user.

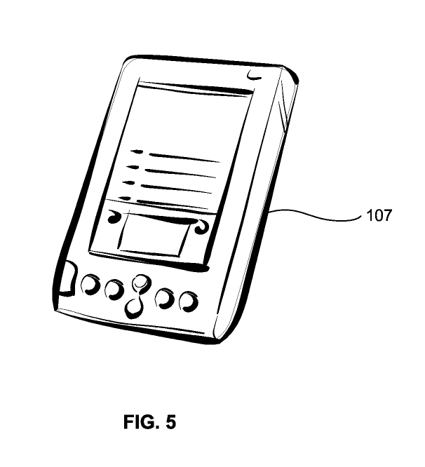

The holding assembly 104 includes a device holder 108 and may be waterproof. The device holder 108 may be a receptacle which is adapted to hold a data capturing device 107 (e.g., such as the data capturing device 107 of FIG. 5). The device holder 108 may include one or more ports (not shown) on its wall surface. Examples of the data capturing device 107 include a mobile phone/smartphone, a digital camera, a voice recorder, a mini tablet computer, etc. In one embodiment, the data capturing device 107 is a mobile communication device which includes an image capturing unit for capturing an image (e.g., a photo, video, etc.) associated with a user. The data capturing device 107 may include features such as a self-timer, a burst-mode, a capture time, and a playback time. The self-timer feature delays capturing data (e.g., a picture of a user) for a pre-determined time. The burst-mode feature allows a user to take a series of picture in a quick succession. The capture time, and the playback time feature allows a user to take a series of picture, and stitch them into a timelapse video. In one embodiment, the data capturing device 107 captures data or multimedia content (e.g., a picture associated with a user) through the one or more ports on the wall surface of the device holder 108.

When the holding assembly 104 is configured as a waterproof protective case, this protects the data capturing device 107, in the device holder 108, from coming into contact with water or other liquids. In one embodiment, the device holder 108 itself acts as a waterproof protective case, and the hands-free device accessory 100 does not require an additional holding assembly 104.

The flexible positioning system 106 is adapted to connect the support structure 102 with the holding assembly 104. In one embodiment, the flexible positioning system 106 connects the support structure 102 with the device holder 108. The flexible positioning system 106 includes a first end 112 and a second end 114. In the embodiment shown in FIG. 1A, the first end 112 is attached and extends out from the support structure 102. The second end 114 is attached to the device holder 108. A user can extend, and/or contract the flexible positioning system 106 partially or completely for adjusting its length, and can selectively position the flexible positioning system 106 at a desired position. A position associated with the flexible positioning system 106 which is attached to the holding assembly 104, may be fixed relative to a user. For example, the user can fix the flexible positioning system 106 to his/her front to enable it to capture an image of the user and his/her surroundings. The flexible positioning system 106 may remain fixed in the same position relative to the user even when the user moves. In one embodiment, the maximum length (i.e., when flexible positioning system 106 in its full extension) of the flexible positioning system 106 may be approximately 36 inches, for example; although other maximum lengths are possible. In one embodiment, the flexible positioning system 106 is foldable for easy carrying of the hands-free device accessory 100 with the user and storage. In one embodiment, the flexible positioning system 106 may include a plurality of connector pieces (not shown) that join together in ball and socket joint fashion. A pivotable movement may occur between portion connecting ball and socket, and provides elastic functionality to the flexible positioning system 106. In one embodiment, the device holder 108 is extensible to a hand position of a user by extending and/or contracting the flexible positioning system 106. In one embodiment, a lock assembly 109 can be employed for fixing the flexible positioning system 106 at a position, even when a user moves. The lock assembly 109 may include a turner, a locking plug, and a locking groove (not shown), and while the drawings depict the lock assembly 109 to be positioned adjacent or near the first end 112, the lock assembly 109 is not restricted to be positioned at this location, but rather the lock assembly 109 may be configured along any position of the flexible positioning system 106 between/at the first end 112 and the second end 114. Locking the flexible positioning system 106 may be performed by turning the turner, and the locking plug may rotate downwardly, and inserted into the locking groove, for example.

In the embodiments shown in FIGS. 1A and 1B, the flexible positioning system 106 extends out from the front of a user to allow the user to capture multimedia content. For example, the user adjusts a position of the flexible positioning system 106 to the front of the user, and fixes at the desired position such that a data capturing device 107 in the device holder 108 focuses the image of the user. The flexible positioning system 106 may be used in a completely extended position or in a semi-extended position. The flexible positioning system 106 that is attached to the holding assembly 104 is fixed relative to the user at the same position in one embodiment even when in a semi-extended position through the use of the lock assembly 109. The user captures content (e.g., an image, audio, video, biometric, etc.) associated with the user based on the data capturing device 107 without holding the data capturing device 107 by the hand of the user (e.g., hands-free).

For instance, the user may intend to take a self-picture. The user extends the flexible positioning system 106 to the front of the user, and fixes at a position such that the data capturing device 107 focuses the user. The user can then capture their own picture based on the data capturing device 107 at the holding assembly 104 using a timing mechanism on the data capturing device 107 or by audio command, etc. However, the user can also use the hands-free device accessory 100 to capture other data or multimedia content (e.g., an image of another user, surroundings, etc) that is not associated with the user simply by adjusting the position of the hands-free device accessory 100 or holding assembly 104 or data capturing device 107 or simply by the user adjusting his/her own position.

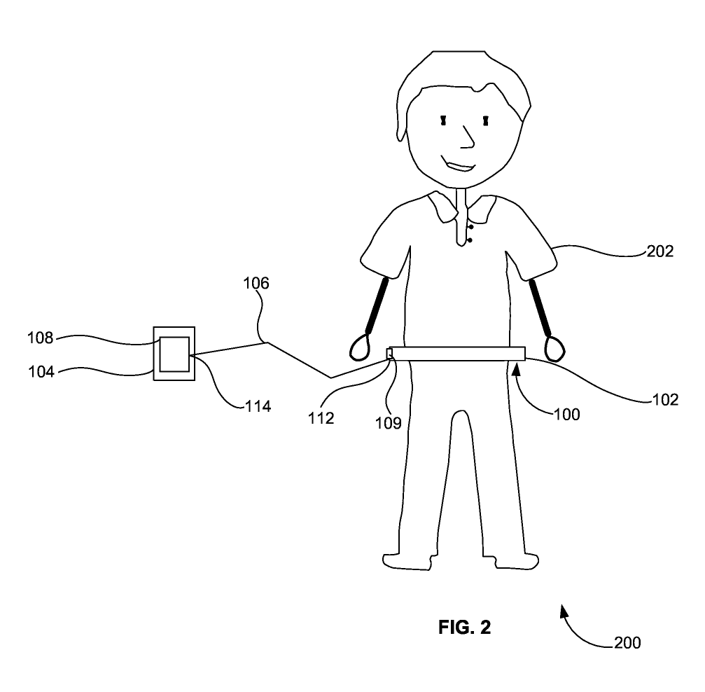

FIG. 2, with reference to FIG. 1A, illustrates a front view 200 of the hands-free device accessory 100 that includes the support structure 102 which is adapted to fit the torso of a user 202, and the flexible positioning system 106 of FIG. 1A in a partially extended state according to an embodiment herein. The front view 200 of FIG. 2 could also be configured to work with the embodiment shown in FIG. 1B using an attachment mechanism such as a clip 105. The user 202 may extend the flexible positioning system 106 partially, and position the flexible positioning system 106, as shown in the FIG. 2. Similarly, the user 202 can extend and/or contract the flexible positioning system 106, and position the flexible positioning system 106 at varying lengths (e.g., a fixed distance from the user 202) to adjust a distance between a data capturing device 107 in the device holder 108, and the user 202. In one embodiment, the fixed distance is at or greater than a typical arm's length of the user 202.

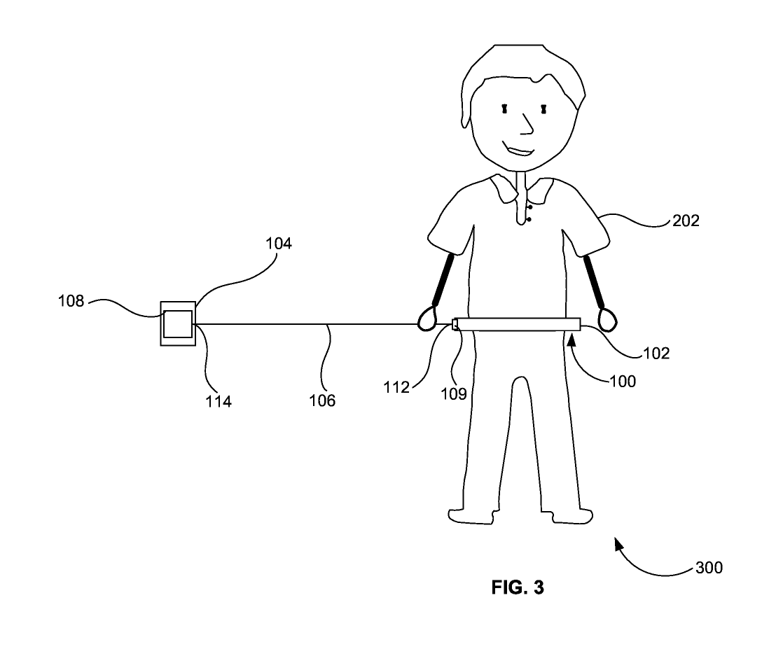

FIG. 3, with reference to FIGS. 1A through 2, illustrates a front view 300 of the hands-free device accessory 100 that includes the support structure 102 which is adapted to fit the torso of the user 202 of FIG. 2, and the flexible positioning system 106 of FIG. 1A in a fully extended state according to an embodiment herein. The user 202 extends the flexible positioning system 106 completely, and fixes at a position as shown in the FIG. 3. The front view 300 of FIG. 3 could also be configured to work with the embodiment shown in FIG. 1B using a clip 105. While FIGS. 2 and 3 show the hands-free device accessory 100 extending from the side of the user 202, the hands-free device accessory 100 may actually be configured to permit extension from any side, including the front and back and any angle, of the user 202.

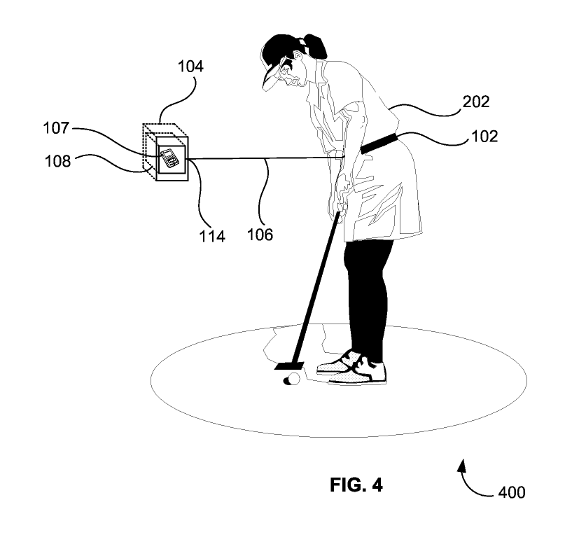

FIG. 4, with reference to FIGS. 1A through 3, illustrates a side view 400 example of a user 202 of the hands-free device accessory 100 that includes the support structure 102 which is adapted to fit the torso of a user 202, and the flexible positioning system 106 of FIG. 1A in a fully extended state according to an embodiment herein. The side view 400 of FIG. 4 could also be configured to work with the embodiment shown in FIG. 1B using a clip 105. In the example of FIG. 4, the user 202 intends to capture his/her own data (e.g., an image, etc.) while playing a game (e.g., golf), although the user 202 may be engaging in any type of activity or simply just standing/sitting/laying down, etc. The user 202 fastens the support structure 102 onto the body (e.g., torso of the user 202 as shown in the FIG. 4). The user 202 then extends the flexible positioning system 106 partially from the front, and positions it at a fixed distance from the user 202 to effectively capture the data associated with the user 202 using a data capturing device 107. The position of the flexible positioning system 106, which is attached to the holding assembly 104, is fixed relative to the user 202, even when the user 202 moves by using the lock assembly 109. The data capturing device 107 in the device holder 108 captures the data (e.g., a photo and/or a video and/or audio and/or biometric etc.) associated with the user 202 while playing the game, for example.

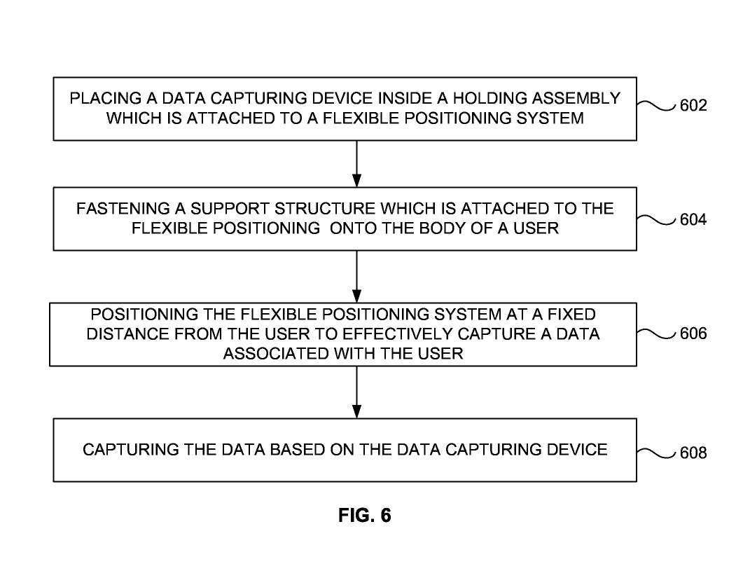

FIG. 5, with reference to FIGS. 1A through 4, is an example of a data capturing device 107 used in accordance with the embodiments herein. FIG. 6, with reference to FIGS. 1 through 5, is a flow diagram illustrating a method of capturing data associated with a user 202 without holding a data capturing device 107 using the user's hands (e.g., hands-free) when the data is being captured using the hands-free device accessory 100 according to an embodiment herein. In step 602, a data capturing device 107 is placed inside the holding assembly 104 which is attached to the flexible positioning system 106. In step 604, the support structure 102 (or clip 105), which is attached to the flexible positioning system 106, is fastened onto the body of the user 202. In step 606, the flexible positioning system 106 is positioned at a fixed distance from the user 202 to effectively capture a data (e.g., audio or visual data which includes an image/picture/video/biometric etc.) associated with the user 202. In step 608, the data is captured based on the data capturing device 107.

The hands-free device accessory 100 allows a user 202 to capture multimedia content based on a data capturing device 107 without necessarily holding the device 107 with the user's hand (e.g., hands-free). The hands-free device accessory 100 is portable, and is configured to fit the body of the user 202. A position of the flexible positioning system 106, which is attached to the holding assembly 104, is fixed relative to the user 202. Hence, even when the user 202 is in motion, the data capturing device 107 captures data content (e.g., multimedia content) with good quality. The user 202 is free to move anywhere, and still capture his/her own multimedia content (e.g., an image/video/audio/biometric, etc.) without holding the data capturing device 107 with the user's hand. The length of the flexible positioning system 106 is extended and/or contracted such that the user 202 can capture the multimedia content from a desired fixed distance. Also, the flexible positioning system 106 can be fixed at a desired angle with respect to the user 202. The diameter associated with the support structure 102 can be adjusted such that the same hands-free device accessory 100 fits for various users 202. Additionally, while the flexible positioning system 106 is generally shown to be along the same horizontal plane of the user 202 in the various figures, the flexible positioning system 106 may be configured to extend at an angle (e.g., upwards/downwards) from the horizontal plane of the user 202.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A device accessory system comprising:
a support structure adapted to attach to a user;
a holding assembly comprising a device holder adapted to secure a data capturing device, wherein said data capturing device is adapted to capture data; and
an extendable and collapsible flexible positioning system that is positionable at varying lengths and angles to adjust a distance or angle between said data capturing device and said user, wherein said flexible positioning system comprises:
a first end coupled to said support structure; and
a second end coupled to said holding assembly, wherein said data is captured once said flexible positioning system is positioned at a fixed distance or angle from said user, and wherein said user does not have to hold said data capturing device while said data is being captured.

2. The device accessory system of claim 1, wherein any of said holding assembly and said device holder is waterproof.

3. The device accessory system of claim 1, wherein said data comprises any of audio, video, image, and biometric data.

4. The device accessory system of claim 1, wherein said support structure is adapted to fit around said user.

5. The device accessory system of claim 1, wherein said support structure comprises a clip.

6. The device accessory system of claim 1, wherein said support structure is detachable.

7. The device accessory system of claim 1, wherein said support structure is adjustable.

8. The device accessory system of claim 1, wherein any of said holding assembly, said device holder, and said data capturing device is movable.

9. The device accessory system of claim 1, further comprising a lock assembly operatively connected to said flexible positioning system.

10. The device accessory system of claim 9, wherein said lock assembly is positioned adjacent to said first end.

11. A device accessory system comprising:
a support structure adapted to operatively connect to a user;
a holding assembly comprising a device holder adapted to hold a mobile communication device, wherein said mobile communication device is adapted to capture data;
an extendable and collapsible flexible positioning system that is positionable at varying lengths and angles to adjust a distance or angle between said mobile communication device and said user, wherein said flexible positioning system comprises a first end coupled to said support structure, and a second end coupled to said holding assembly, wherein said data is captured once said flexible positioning system is positioned at a fixed distance or angle relative to said user, and wherein said data is captured in a hands-free utilization by said user; and
a lock assembly operatively connected to said flexible positioning system.

12. The device accessory system of claim 11, wherein any of said holding assembly and said device holder is waterproof.

13. The device accessory system of claim 11, wherein said data comprises any of audio, video, image, and biometric data.

14. The device accessory system of claim 11, wherein said lock assembly is positioned adjacent to said first end.

15. The device accessory system of claim 11, wherein said lock assembly comprises a turner, a locking plug, and a locking groove.

16. The device accessory system of claim 11, wherein said support structure is adapted to fit around said user.

17. The device accessory system of claim 11, wherein said support structure comprises a clip.

18. The device accessory system of claim 11, wherein said support structure is detachable.

19. The device accessory system of claim 11, wherein said support structure is adjustable.

20. The device accessory system of claim 11, wherein any of said holding assembly, said device holder, and said mobile communication device is movable.
